(19) United States
(12) Patent Application Publication
(10) Pub. No.: US 2025/0133069 A1
(43) Pub. Date: Apr. 24, 2025

(54) DEVICE ACCESS METHOD AND SYSTEM AND NON-VOLATILE COMPUTER STORAGE MEDIUM

(71) Applicant: BOE Technology Group Co., Ltd., Beijing (CN)

(72) Inventors: Hongjun DU, Beijing (CN); Tao LI, Beijing (CN); Xingxing ZHAO, Beijing (CN)

(21) Appl. No.: 18/695,846

(22) PCT Filed: Jul. 5, 2023
(86) PCT No.: PCT/CN2023/105810

§ 371 Date: Mar. 27, 2024

(30) Foreign Application Priority Data
Jul. 15, 2022 (CN) 202210837641.7

(51) Int. Cl. H04L 9/40

(52) U.S. Cl. CPC H04L 63/0442; H04L 63/083

(57) ABSTRACT

A device access method applied to a host and includes: acquiring a connection request provided by a terminal, where the connection request comprises an identifier of the terminal and a password corresponding to the identifier, and the password is generated based on a private key in a key pair and the identifier; acquiring a verification result of the password, where the password is configured to be verified by a public key in the key pair; establishing a connection with the terminal in response to a successful verification; and rejecting the connection request of the terminal in response to a failed verification.

The present disclosure is a US national stage of international application No. PCT/CN2023/105810, filed on Jul. 5, 2023, which claims priority to Chinese Patent Application No. 202210837641.7 filed on Jul. 15, 2022 and entitled “DEVICE ACCESS METHOD AND SYSTEM, AND NON-VOLATILE COMPUTER STORAGE MEDIUM”, the content of which are incorporated herein by reference in their entireties.

### TECHNICAL FIELD

The present disclosure relates to the field of device access technologies, and in particular, relates to a device access method and system, and a non-volatile computer storage medium.

### BACKGROUND OF THE INVENTION

A device access method is a method for connecting devices. Currently, in order to ensure the security of the connection, security verification is performed when two devices are in contact (such as a terminal and a host).

In the device access method, a host sends user names and passwords to a plurality of terminals. When the plurality of terminals want to connect with the host, they can send the user names and the passwords to the host, the host compares the user names and the passwords with the locally stored user names and passwords, and connects with the terminals if the comparison is successful and refuses to connect with the terminals if the comparison fails.

However, in the above method, if the passwords and the user names sent by the terminals are intercepted, the host is difficult to know whether other terminals are connected with the host by these passwords and identifiers, which results in low security of the above device access method.

### SUMMARY OF THE INVENTION

Embodiments of the present disclosure provide a device access method and system, and a non-volatile computer storage medium. The technical solutions are as follows.

According to an aspect of the embodiments of the present disclosure, a device access method is provided. The method is applied to a host and includes:
acquiring a connection request provided by a terminal, the connection request including an identifier of the terminal and a password corresponding to the identifier, and the password being generated based on a private key in a key pair and the identifier;
acquiring a verification result of the password, the password being configured to be verified by a public key in the key pair;
establishing a connection with the terminal, in response to a successful verification; and
rejecting the connection request of the terminal in response to a failed verification.

In some embodiments, said acquiring the verification result of the password includes:
sending the identifier of the terminal and the password corresponding to the identifier to a verifying module, the verifying module being configured to verify the password through the public key in the key pair; and
receiving a verification result fed back by the verifying module.

In some embodiments, the connection request further includes a user name corresponding to the identifier, and the password is generated based on the private key in the key pair, the identifier and the user name; and
said sending the identifier of the terminal and the password corresponding to the identifier to the verifying module includes:
sending the identifier of the terminal, the user name corresponding to the identifier and the password corresponding to the identifier to the verifying module.

In some embodiments, said acquiring the verification result of the password includes:
decrypting the password through the public key in the key pair to acquire decrypted data;
generating digest data of the identifier of the terminal;
verifying whether the decrypted data is the same as the digest data;
determining that the verification is successful in response to the decrypted data being the same as the digest data; and
determining that the verification fails in response to the decrypted data differing from the digest data.

In some embodiments, before the connection request provided by the terminal is acquired, the method further includes:
acquiring the identifier of the terminal;
generating the password based on the private key in the key pair and the identifier; and
configuring the password into the terminal.

According to another aspect of the embodiments of the present disclosure, a device access method is provided. The method is applied to a terminal and includes:
sending a connection request to a host in response to acquiring a login indication signal, the connection request including an identifier of the terminal and a password corresponding to the identifier, the password being generated based on a private key in a key pair and the identifier, and the host being configured to verify the password based on a public key in the key pair; and
establishing a connection with the host in response to a successful verification.

In some embodiments, before sending the connection request to the host in response to acquiring the login indication signal, the method further includes:
providing the identifier of the terminal for a configuration device; and
receiving the password provided by the configuration device.

According to another aspect of the embodiments of the present disclosure, a device access method is provided. The method is applied to a configuration device and includes:
acquiring a key pair, the key pair including a private key and a public key corresponding to the private key;
providing the key pair to a verifying module;
acquiring an identifier of a terminal;
providing the identifier for the verifying module, the verifying module being configured to generate a password based on the private key in the key pair and the identifier;
acquiring a password provided by the verifying module; and
configuring the password into the terminal, the terminal being configured to establish a connection with a host through the password and the identifier.

In some embodiments, the verifying module is configured to generate a user name of the terminal, and generate the password, based on the private key in the key pair, the user name and the identifier and
said acquiring the password provided by the verifying module includes:
acquiring the user name and the password which correspond to the identifier provided by the verifying module.

According to another aspect of the embodiments of the present disclosure, a device access system is provided. The system includes a host and a terminal; wherein
the terminal is configured to send a connection request to the host, the connection request including an identifier of the terminal and a password corresponding to the identifier, and the password being generated based on a private key in a key pair and the identifier; and
the host is configured to acquire a verification result of the password, the password being configured to be verified by a public key in the key pair;
establish a connection with the terminal, in response to a successful verification; and
reject the connection request of the terminal in response to a failed verification.

In some embodiments, the system further includes a verifying module, and
the host is configured to send the identifier of the terminal and the password corresponding to the identifier to the verifying module;
the verifying module is configured to verify the password through the public key in the key pair; and
the host is configured to receive a verification result fed back by the verifying module.

In some embodiments, the verifying module is configured to:
decrypt the password through the public key in the key pair to acquire decrypted data;
generate digest data of the identifier of the terminal;
verify whether the decrypted data is the same as the digest data;
determine that the verification is successful in response to the decrypted data being the same as the digest data; and
determine that the verification fails in response to the decrypted data differing from the digest data.

According to another aspect of the embodiments of the present disclosure, a non-volatile computer storage medium is provided. The non-volatile computer storage medium stores at least one instruction, at least one program, a code set, or an instruction set therein, wherein a processor, when loading and executing the at least one instruction, the at least one program, the code set, or the instruction set, is caused to perform the device access method described above.

A computer program product or a computer program including at least one computer instruction is provided. The at least one computer instruction is stored in a computer-readable storage medium. A processor of a computer device, when reading and executing the at least one computer instruction from the computer-readable storage medium, causes the computer device to perform the device access method described above.

The technical solutions according to the embodiments of the present disclosure at least achieve the following beneficial effects.

Passwords corresponding to identifiers are configured for terminals in an asymmetric encryption mode, so that each terminal has an independent password, in the case that the terminals initiate a connection request through the passwords, the passwords can be verified based on a public key, and as the identifier and the password of each terminal are different, the host may timely know when a plurality of terminals are connected with a host through the same identifier and the same password, such that the problem of low security of a device access method in the related art is solved, and the effect of improving the security of the device access method is achieved.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of a device access system according to an embodiment of the present disclosure;

FIG. 2 is a flowchart of a device access method according to an embodiment of the present disclosure;

FIG. 3 is a flowchart of another device access method according to an embodiment of the present disclosure;

FIG. 4 is another schematic structural diagram of a device access system according to an embodiment of the present disclosure;

FIG. 5 is a flowchart of another device access method according to an embodiment of the present disclosure;

FIG. 6 is a flowchart of another device access method according to an embodiment of the present disclosure;

FIG. 7 is a flowchart of another device access method according to an embodiment of the present disclosure;

FIG. 8 is a flowchart of password verification in the embodiment as shown in FIG. 7;

FIG. 9 is a block diagram of an apparatus for device access according to an embodiment of the present disclosure;

FIG. 10 is a block diagram of another apparatus for device access according to an embodiment of the present disclosure; and

FIG. 11 is a block diagram of another apparatus for device access according to an embodiment of the present disclosure.

The above drawings have shown the explicit embodiments of the present disclosure, which will be described below in detail. These drawings and text descriptions are not intended to limit the scope of the conception of the present disclosure in any way, but to illustrate the concept of the present disclosure to those skilled in the art with reference to specific embodiments.

### DETAILED DESCRIPTION OF THE INVENTION

For clearer descriptions of the objects, technical solutions, and advantages of the present disclosure, embodiments of the present disclosure are further described in detail below with reference to the accompanying drawings.

The Internet of things (IoT), i.e., the Internet connected with everything, is an extended and expanded network on the basis of the Internet, combines various information sensing devices with the network to form a huge network, and achieves the interconnection and intercommunication of people, machines and things at various time points and places.

The Internet of things may include a host and a plurality of terminals, and the plurality of terminals may include devices with various functions and purposes, for example, may include various sensors, such as sensors to collect data and information about sound, light, temperature, and electricity. The terminals may establish a connection with the host via various wireless networks and wired networks and interact with the host, for example, may transmit the collected data and information to the host.

The Internet of things may be applied to various scenarios, such as smart home, site supervisory control, and intelligent transportation.

In the case that a terminal establishes a connection with the host, the host needs to verify the identifier of the terminal so as to avoid the connection between an unauthorized terminal and the host. For a plurality of terminals in a certain scenario, the same user name and the same password are usually used, the host may send the user name and the password to the plurality of terminals, and each of the plurality of terminals may establish a connection with the host through the user name and the password.

However, if the password and the user name are intercepted by a malicious terminal, the malicious terminal can also establish a connection with the host through the password and the user name, which may cause a serious impact on the security of the Internet of things.

Embodiments of the present disclosure provide a device access method and system, and a non-volatile computer storage medium, which can solve some of the aforementioned technical problems.

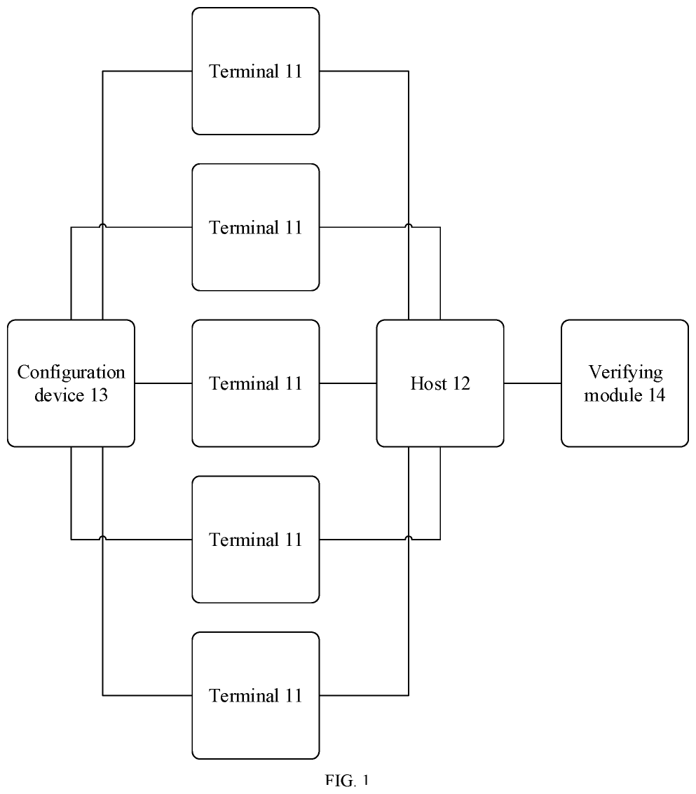

FIG. 1 is a schematic structural diagram of a device access system according to an embodiment of the present disclosure, where the device access system includes terminals 11 and a host 12, and the terminals 11 are capable of establishing a wired connection or a wireless connection with the host 12.

The terminals 11 include various terminals such as a smart home device, a smart phone, a tablet computer, and a camera. The quantity of terminals 11 is plural, and FIG. 1 shows a case where the quantity of the terminals 11 is 5, but it is not limited thereto.

The host 12 may include a device having data processing and transmission functions, and the host 12 is disposed in a server (e.g., a message queuing telemetry transport (MQTT) server).

Moreover, the device access system further includes a configuration device 13 and a verifying module 14. The configuration device 13 may include terminals used by a configuration person, and the configuration device 13 is capable of establishing a wired connection or a wireless connection with the terminals 11, the host 12 and the verifying module 14.

The verifying module 14 may combine with a server and be arranged in the server, or may combine with the host 12 and be arranged in the host 12, or the verifying module 14 may also be an independent device, which is not limited in the embodiments of the present disclosure.

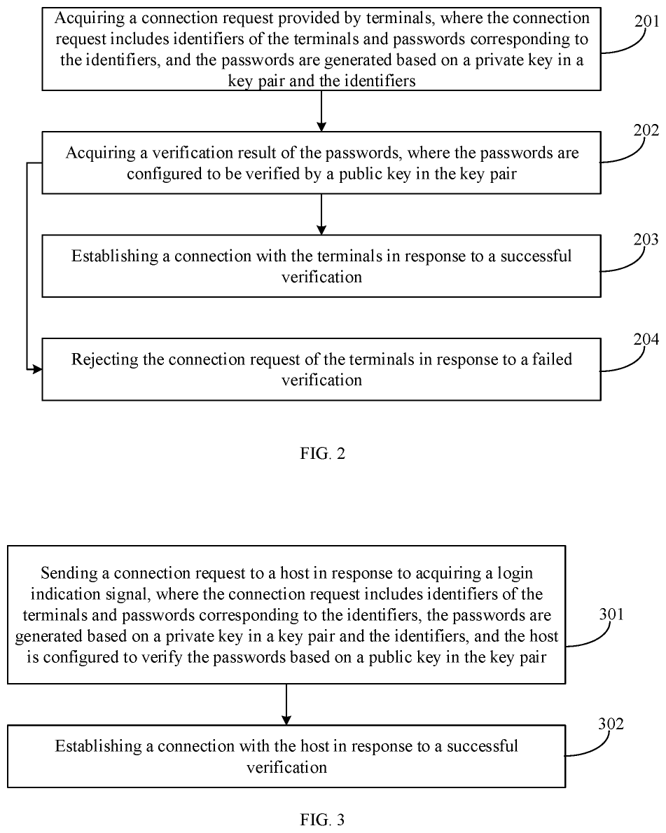

FIG. 2 is a flowchart of a device access method according to an embodiment of the present disclosure, where the method is applied to the host in the device access system shown in FIG. 1, and the method includes the following steps
step 201, acquiring a connection request provided by terminals, where the connection request includes identifiers of the terminals and passwords corresponding to the identifiers, and the passwords are generated based on a private key in a key pair and the identifiers;
step 202, acquiring a verification result of the passwords, where the passwords are configured to be verified by a public key in the key pair;
step 203, establishing a connection with the terminals in response to a successful verification; and
step 204, rejecting the connection request of the terminals in response to a failed verification.

In summary, in the device access method according to the embodiments of the present disclosure, passwords corresponding to identifiers are configured for terminals in an asymmetric encryption mode, so that each terminal has an independent password, in the case that the terminals initiate a connection request through the passwords, the passwords can be verified based on a public key, and as the identifier and the password of each terminal are different, the host may timely know when a plurality of terminals are connected with a host through the same identifier and the same password, such that the problem of low security of a device access method in the related art is solved, and the effect of improving the security of the device access method is achieved.

FIG. 3 is a flowchart of another device access method according to an embodiment of the present disclosure, where the method is applied to the terminals in the device access system shown in FIG. 1, and the method includes the following steps:
step 301, sending a connection request to a host in response to acquiring a login indication signal, where the connection request includes identifiers of the terminals and passwords corresponding to the identifiers, the passwords are generated based on a private key in a key pair and the identifiers, and the host is configured to verify the passwords based on a public key in the key pair; and
step 302, establishing a connection with the host in response to a successful verification.

In summary, in the device access method according to the embodiments of the present disclosure, passwords corresponding to identifiers are configured for terminals in an asymmetric encryption mode, so that each terminal has an independent password, in the case that the terminals initiate a connection request through the passwords, the passwords can be verified based on a public key, and as the identifier and the password of each terminal are different, the host may timely know when a plurality of terminals are connected with a host through the same identifier and the same password, such that the problem of low security of a device access method in the related art is solved, and the effect of improving the security of the device access method is achieved.

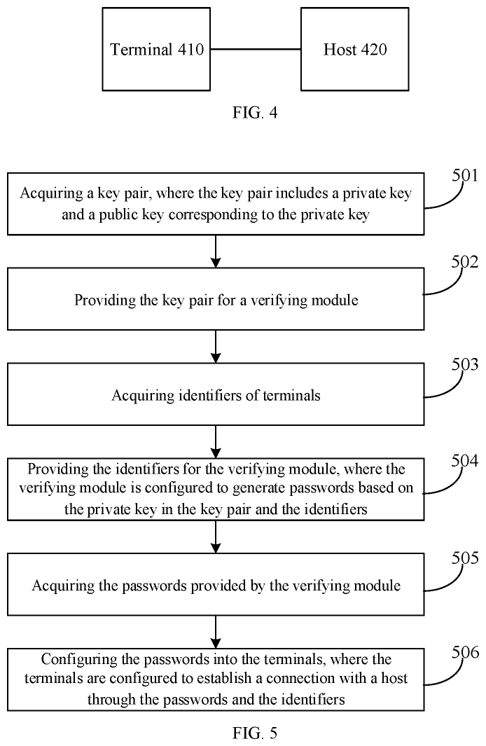

FIG. 4 is another schematic structural diagram of a device access system according to an embodiment of the present disclosure, and the system includes a terminal 410 and a host 420.

The terminal 410 is configured to send a connection request to the host, the connection request includes an identifier of the terminal and password corresponding to the identifier, and the password is generated based on a private key in a key pair and the identifier.

The host 420 is configured to acquire a verification result of the password, and the password is configured to be verified by a public key in the key pair;
establish a connection with the terminal 410 in response to a successful verification; and
reject the connection request of the terminal 410, in response to a failed verification.

In summary, in the device access system according to the embodiments of the present disclosure, a password corresponding to an identifier is configured for a terminal in an asymmetric encryption mode, so that each terminal has an independent password, in the case that the terminal initiates a connection request through the password, the password can be verified based on a public key, and as the identifier and the password of each terminal are different, the host may timely know when a plurality of terminals are connected with a host through the same identifier and the same password, such that the problem of low security of a device access method in the related art is solved, and the effect of improving the security of the device access method is achieved.

FIG. 5 is a flowchart of another device access method according to an embodiment of the present disclosure, where the method is applied to the configuration device in the device access system shown in FIG. 1, and the method includes the following steps.
step 501, acquiring a key pair, the key pair including a private key and a public key corresponding to the private key;
step 502, providing the key pair to a verifying module;
step 503, acquiring identifiers of terminals;
step 504, providing the identifiers to the verifying module, where the verifying module is configured to generate passwords based on the private key in the key pair and the identifiers;
step 505, acquiring the passwords provided by the verifying module; and
step 506, configuring the passwords into the terminals, where the terminals are configured to establish a connection with a host through the passwords and the identifiers.

In summary, in the device access method according to the embodiments of the present disclosure, passwords corresponding to identifiers are configured for terminals in an asymmetric encryption mode, so that each terminal has an independent password, in the case that the terminals initiate a connection request through the passwords, the passwords can be verified based on a public key, and as the identifier and the password of each terminal are different, the host may timely know when a plurality of terminals are connected with a host through the same identifier and the same password, such that the problem of low security of a device access method in the related art is solved, and the effect of improving the security of the device access method is achieved.

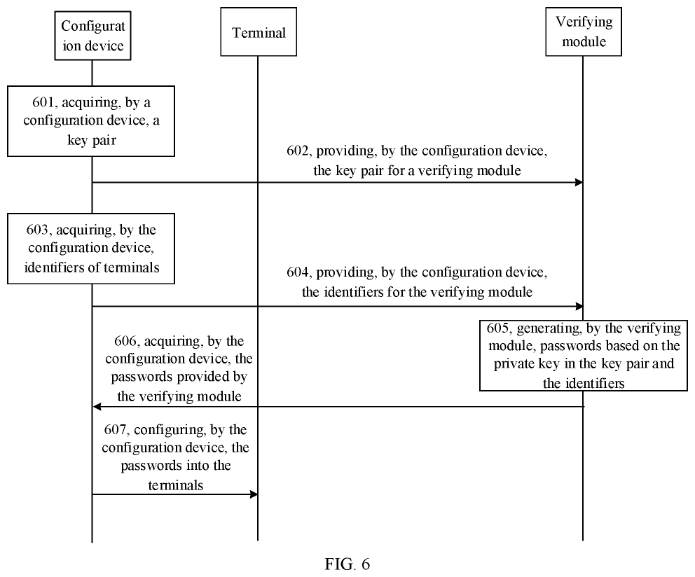

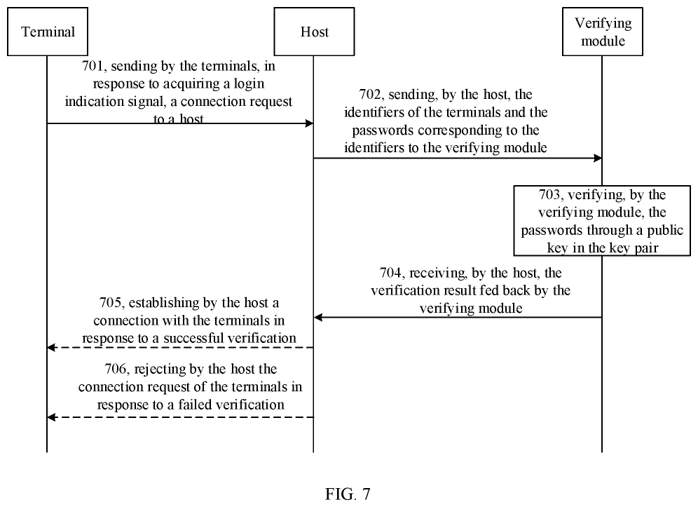

FIG. 6 is a flowchart of another device access method according to an embodiment of the present disclosure, where the method is applied to the device access system shown in FIG. 1, and the method includes the following steps.

In step 601, a configuration device acquires a key pair.

The key pair includes a private key and a public key corresponding to the private key.

The configuration device may generate a private key and generate a corresponding public key through the private key, and a generation algorithm of the private key may include an RSA algorithm, a national secret SM2, or some other private key generation algorithms, which is not limited in the embodiments of the present disclosure.

It should be noted that the public key and the private key are a pair of keys, and data encrypted by one of the keys can only be decrypted by the other key.

In step 602, the configuration device provides the key pair to a verifying module.

In the method according to the embodiments of the present disclosure, the configuration device provides the public key and the private key in the key pair to the verifying module for the verifying module to realize the subsequent verification function.

In an exemplary embodiment, the verifying module may include two sub-modules, which may securely keep the private key and the public key respectively. For example, the verifying module may include a private key generating module and a private key verifying module. The private key may be safely stored in private key generating module, and the public key may be safely stored in the private key verifying module.

Certainly, the public key and the private key in the key pair may also be securely stored at another position (e.g., in a cloud server), such that the verifying module can access the public key and the private key in the key pair.

In the embodiments of the present disclosure, the public key is not an open key, and the public key is safely stored in a preset storage position (e.g., a verifying module) and can be accessed only by a specified device (e.g., the verifying module or a host).

In step 603, the configuration device acquires identifiers of terminals.

The configuration device may acquire identifiers of the terminals in various ways, where the identifier (ID) may be a unique and non-repeating identifier of each terminal in the device access system, and the identifier may be a serial number (SN) of the terminal, or the identifier may be a media access control address (MAC) of the terminal. The identifier may be referred to as a DEVICE_ID.

In an acquisition mode, the configuration device acquires a large number of identifiers of terminals in batches from a manufacturer of the terminals, such that it is convenient to configure passwords for a plurality of terminals at the same time.

In another mode, the configuration device directly acquires identifiers of terminals from the terminals.

In step 604, the configuration device provides the identifiers to the verifying module.

The configuration device provides the acquired identifiers of the terminals to the verifying module holding the key pair.

In step 605, the verifying module generates passwords based on the private key in the key pair and the identifiers.

The verifying module may generate the passwords based on the private key in the key pair and the identifiers, and specifically, the verifying module firstly may generate digest data of the identifiers by using a first digest generation method, and then encrypt the digest data through the private key to acquire the passwords.

The first digest generation method may be various digest algorithms, such as SHA-256, MD5, SHA-1, SHA-512, and state secret SM3 hash algorithm, which is not limited in the embodiments of the present disclosure.

Moreover, the verifying module further generates a user name (e.g., randomly) for each terminal, generates the user names of the terminals and digest information of the identifiers through a digest algorithm, and encrypts the digest information through the private key to acquire the passwords, which may improve the security of the passwords.

The corresponding pseudo-code may be as follows:

DEVICE_SECRET=RSA_SIGN(MESSAGE_DIGEST(DEVICE_ID+USER_NAME),
PRI_KEY).

where DEVICE_SECRET is a password, PRI_KEY is a private key, RSA_SIGN (xxx, PRI_KEY) is to encrypt xxx (sign) through the private key, MESSAGE_DIGEST ( ) is to generate digest data for information in the parentheses, DEVICE_ID is an identifier of a terminal, and USER_NAME is a user name corresponding to the identifier of the terminal.

In an exemplary embodiment, the verifying module generates passwords corresponding to the identifiers of the respective terminals for a plurality of terminals in batches, so as to improve the efficiency of the method according to the embodiments of the present disclosure.

In step 606, the configuration device acquires the passwords provided by the verifying module.

After acquiring the passwords, the verifying module sends the passwords to the configuration device. Because password generation modes are different, in the case that the passwords are generated by the user names and the identifiers, the verifying module provides the passwords and the user names corresponding to the identifiers of the terminals to the configuration device.

In step 607, the configuration device configures the passwords into the terminals.

The configuration device may configure a plurality of passwords into the terminals in batches. In the case that the verifying module provides the passwords and the user names corresponding to the identifiers of the terminals, the configuration device may configure the passwords and the user names corresponding to the identifiers of the plurality of terminals into the terminals in batches. The terminals may attempt to establish a connection with the host through the passwords.

The method according to the embodiments of the present disclosure is a method for configuring passwords (or passwords and user names) for terminals, and the method may be applied before the terminals leave a factory, such that in an aspect, the passwords (or the passwords and the user names) may be configured for the terminals in large batches, and in another aspect, the transmission of data such as the passwords and the key pair after leaving the factory can be avoided, thereby improving the security of the device access method.

Moreover, the host may further configure the passwords into the terminals. For example, the host may acquire identifiers of terminals, generate passwords based on a private key in a key pair and the identifiers, and the'n configure the passwords into the terminals, which is not limited in the embodiments of the present disclosure.

In summary, in the device access method according to the embodiments of the present disclosure, passwords corresponding to identifiers are configured for terminals in an asymmetric encryption mode, so that each terminal has an independent password, in the case that the terminals initiate a connection request through the passwords, the passwords can be verified based on a public key, and as the identifier and the password of each terminal are different, the host may timely know when a plurality of terminals are connected with a host through the same identifier and the same password, such that the problem of low security of a device access method in the related art is solved, and the effect of improving the security of the device access method is achieved.

FIG. 7 is a flowchart of another device access method according to an embodiment of the present disclosure, where the method is applied to the device access system shown in FIG. 1, and the method includes the following steps.

In step 701, terminals send a connection request to a host in response to acquiring a login indication signal.

The terminals may send the connection request to the host under a preset condition. The preset condition may be a case where a device is powered on, or a case where a connection instruction is received, etc., which is not limited in the embodiments of the present disclosure.

The connection request may include identifiers of the terminals and passwords corresponding to the identifiers, and the passwords are generated based on a private key in a key pair and the identifiers. For a specific generation mode of the passwords, reference may be made to the embodiments shown in FIG. 6, and the embodiments of the present disclosure will not be repeated herein.

In an exemplary embodiment, the connection request further includes user names corresponding to the identifiers of the terminals.

In step 702, the host sends the identifiers of the terminals and the passwords corresponding to the identifiers to the verifying module.

After receiving the identifiers of the terminals and the passwords corresponding to the identifiers, the host sends the identifiers of the terminals and the passwords corresponding to the identifiers to the verifying module for verification.

In an exemplary embodiment, in the case that the connection request includes user names corresponding to the identifiers of the terminals, the host sends the user names corresponding to the identifiers of the terminals and the passwords corresponding to the identifiers to the verifying module.

In step 703, the verifying module verifies the passwords through a public key in the key pair.

The passwords are acquired by encrypting the private key corresponding to the public key, and then the verifying module verifies the passwords based on the public key.

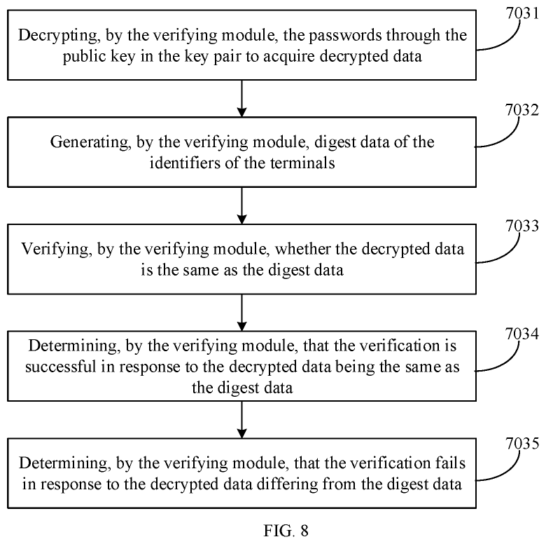

In an exemplary embodiment, referring to FIG. 8, FIG. 8 is a flowchart of password verification in the embodiments as shown in FIG. 7, and step 703 includes sub-step 7031 to sub-step 7035.

In sub-step 7031, the verifying module decrypts the passwords through the public key in the key pair to acquire decrypted data.

The passwords are encrypted by the private key in the key pair, and thus the passwords may be decrypted by the public key in the key pair to acquire the decrypted data.

When being started, the verifying module may load the public key to a memory, and thus the verifying module can complete the verification of the passwords without accessing a database. The process is simplified, and the verification efficiency is improved.

In sub-step 7032, the verifying module generates digest data of the identifiers of the terminals.

A digest generation method for the digest data is an agreed digest generation method, i.e., the same digest generation method as the first digest generation method used in the embodiment shown in FIG. 6.

In an exemplary embodiment, in the case that the passwords are generated from the identifiers of the terminals and the user names, the verifying module may generate the digest data of both the identifiers of the terminals and the user names.

In sub-step 7033, the verifying module verifies whether the decrypted data is the same as the digest data.

In the case that the passwords are correct, the decrypted data is digest data of the identifiers of the terminals (or digest data of both the identifiers of the terminals and the user names), and the verifying module can verify whether the decrypted data is the same as the digest data.

In sub-step 7034, the verifying module determines that the verification is successful in response to the decrypted data being the same as the digest data.

In the case that the decrypted data is the same as the digest data, the passwords are correct, and the verifying module determines that the verification is successful.

In sub-step 7035, the verifying module determines that the verification fails in response to the decrypted data differing from the digest data.

In the case that the decrypted data is different from the digest data, the passwords are wrong, and the verifying module determines that the verification fails.

By the end of sub-step 7035, the verifying module implements the function of verifying the passwords provided by the terminals.

In the related art, the host needs to compare the received user names and passwords with the user names and passwords in the database, resulting in low verification efficiency in the case that a large number of devices attempt to be connected to the host.

In the method according to the embodiments of the present disclosure, in the process of verifying the passwords by the verifying module, the verifying module may verify the passwords provided by the plurality of terminals based on the public key (the public key may be disposed in a local storage medium of the verifying module or at a position convenient for the verifying module to access), and it is not required to compare the passwords with the passwords in the database during password verification, such that the data processing amount is greatly reduced, the password verification speed and efficiency are accelerated, and the verification efficiency of a high-concurrency access scenario is improved.

FIG. 7 is a flowchart of password verification by a verifying module, and in an exemplary embodiment, the passwords may be further verified directly by a host, and in this way, the host performs the following five steps:
1) decrypting the passwords through the public key in the key pair to acquire decrypted data;
2) generating digest data of the identifiers of the terminals;
3) verifying whether the decrypted data is the same as the digest data;
4) determining that the verification is successful in response to the decrypted data being the same as the digest data; and
5) determining that the verification fails in response to the decrypted data differing from the digest data.

Of cause, the verifying module may be further arranged in the host, which is not limited in the embodiments of the present disclosure.

In step 704, the host receives the verification result fed back by the verifying module.

The verification result is configured to indicate whether the passwords provided by the terminals are correct. In the case that the passwords provided by the terminals are correct, the host allows the connection request of the terminals, and in the case that the passwords provided by the terminals are wrong, the host rejects the connection request of the terminals.

FIG. 7 shows a mode in which the host acquires the verification result from the verifying module. However, the host may further directly verify the passwords to acquire the verification result. The mode in which the host verifies the passwords may refer to the mode in which the verifying module verifies the passwords, which is not limited in the embodiments of the present disclosure. In addition, the host may directly verify the passwords through the mode in which the verifying module combines with the host and is arranged in the host.

In step 705, the host establishes a connection with the terminals in response to a successful verification.

In the case that the verification result fed back by the verifying module indicates that the verification is successful, the terminals are authorized users, and the host establishes a connection with the terminals.

In step 706, the host rejects the connection request of the terminals in response to a failed verification.

In the case that the verification result fed back by the verifying module indicates that the verification fails, the terminals are unauthorized users, and the host rejects the connection with the terminals.

After rejecting the connection request of the terminals, the host sends a prompt to the terminals, such as, a prompt about a password error or a login failure, such that the terminals log in again or send a notification to a management device (which may be controlled by an operator), so as to avoid that the terminals cannot be connected to the host due to the password error caused by a program error.

In summary, in the device access method according to the embodiments of the present disclosure, passwords corresponding to identifiers are configured for terminals in an asymmetric encryption mode, so that each terminal has an independent password, in the case that the terminals initiate a connection request through the passwords, the passwords can be verified based on a public key, and as the identifier and the password of each terminal are different, the host may timely know when a plurality of terminals are connected with a host through the same identifier and the same password, such that the problem of low security of a device access method in the related art is solved, and the effect of improving the security of the device access method is achieved.

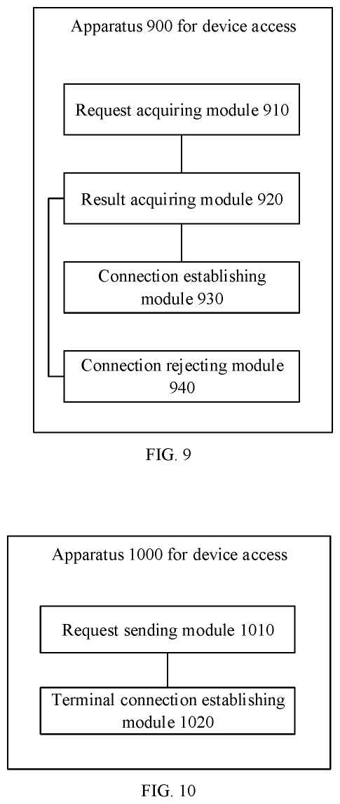

FIG. 9 is a block diagram of an apparatus for device access according to an embodiment of the present disclosure, where the apparatus is applied to the host in the device access system shown in FIG. 1, and the apparatus 900 for device access includes:
a request acquiring module 910, configured to acquire a connection request provided by terminals, where the connection request includes identifiers of the terminals and passwords corresponding to the identifiers, and the passwords are generated based on a private key in a key pair and the identifiers;
a result acquiring module 920, configured to acquire a verification result of the passwords, where the passwords are configured to be verified by a public key in the key pair;
a connection establishing module 930, configured to establish a connection with the terminals in response to a successful verification; and
a connection rejecting module 940, configured to reject the connection request of the terminals in response to a failed verification.

In summary, in the apparatus for device access according to the embodiments of the present disclosure, passwords corresponding to identifiers are configured for terminals in an asymmetric encryption mode, so that each terminal has an independent password, in the case that the terminals initiate a connection request through the passwords, the passwords can be verified based on a public key, and as the identifier and the password of each terminal are different, the host may timely know when a plurality of terminals are connected with a host through the same identifier and the same password, such that the problem of low security of a device access method in the related art is solved, and the effect of improving the security of the device access method is achieved.

FIG. 10 is a block diagram of another apparatus for device access according to an embodiment of the present disclosure, where the apparatus is applied to the terminals in the device access system shown in FIG. 1, and the apparatus 1000 for device access includes:
a request sending module 1010, configured to send a connection request to a host in response to acquiring a login indication signal, where the connection request includes identifiers of the terminals and passwords corresponding to the identifiers, the passwords arre generated based on a private key in a key pair and the identifiers, and the host is configured to verify the passwords based on a public key in the key pair; and
a terminal connection establishing module 1020, configured to establish a connection with the host in response to a successful verification.

In summary, in the apparatus for device access according to the embodiments of the present disclosure, passwords corresponding to identifiers are configured for terminals in an asymmetric encryption mode, so that each terminal has an independent password, in the case that the terminals initiate a connection request through the passwords, the passwords can be verified based on a public key, and as the identifier and the password of each terminal are different, the host may timely know when a plurality of terminals are connected with a host through the same identifier and the same password, such that the problem of low security of a device access method in the related art is solved, and the effect of improving the security of the device access method is achieved.

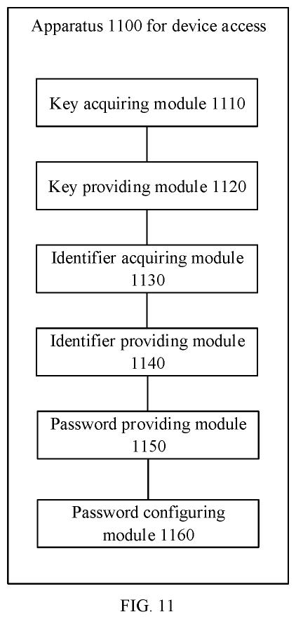

FIG. 11 is a block diagram of another apparatus for device access according to an embodiment of the present disclosure, where the apparatus for device access is applied to the configuration device in the device access system shown in FIG. 1, and the apparatus 1100 for device access includes:
a key acquiring module 1110, configured to acquire a key pair, where the key pair includes a private key and a public key corresponding to the private key;
a key providing module 1120, configured to provide the key pair for a verifying module;
an identifier acquiring module 1130, configured to acquire identifiers of terminals;
an identifier providing module 1140, configured to provide the identifiers for the verifying module, where the verifying module is configured to generate passwords based on the private key in the key pair and the identifiers;
a password providing module 1150, configured to acquire the passwords provided by the verifying module; and
a password configuring module 1160, configured to configure the passwords into the terminals, where the terminals are configured to establish a connection with a host through the passwords and the identifiers.

In summary, in the apparatus for device access according to the embodiments of the present disclosure, passwords corresponding to identifiers are configured for terminals in an asymmetric encryption mode, so that each terminal has an independent password, in the case that the terminals initiate a connection request through the passwords, the passwords can be verified based on a public key, and as the identifier and the password of each terminal are different, the host may timely know when a plurality of terminals are connected with a host through the same identifier and the same password, such that the problem of low security of a device access method in the related art is solved, and the effect of improving the security of the device access method is achieved.

The embodiments of the present disclosure further provide a non-volatile computer storage medium. The non-volatile computer storage medium stores at least one instruction, at least one program, a code set, or an instruction set therein, wherein a processor, when loading and executing the at least one instruction, the at least one program, the code set, or the instruction set, is caused to perform the device access method described above.

Embodiments of the present disclosure further provide a computer program product or a computer program including at least one computer instruction. The at least one computer instruction is stored in a computer-readable storage medium. A processor of a computer device, when reading and executing the at least one computer instruction from the computer-readable storage medium, causes the computer device to perform the device access method described above.

In the present disclosure, the term “first” is merely used for descriptive purposes and should not be construed as indicating or implying the relative importance. The term “a plurality of” refers to two or more, unless otherwise explicitly defined.

In the several embodiments provided in the present disclosure, it should be understood that the disclosed apparatus and method may be implemented in other manners. For example, the above-described apparatus embodiments are merely illustrative. For example, the division of the units is only one type of logical functional division, and other divisions may be realized in practice, for example, a plurality of units or components may be combined or integrated into another system, or some features may be omitted, or not executed. In addition, the shown or discussed mutual coupling or direct coupling or communication connection may be an indirect coupling or communication connection through some interfaces, apparatuses or units, and may be in an electrical, mechanical or other form.

The units described as separate parts may or may not be physically separate, and parts displayed as units may or may not be physical units, may be located in one position, or may be distributed on a plurality of network units. Some or all of the units can be selected according to actual needs to achieve the purpose of the solutions of the embodiments.

It will be appreciated by those of ordinary skill in the art that all or a part of the steps for implementing the above embodiments is completed by hardware, or is completed by instructing relevant hardware by a program stored in a computer-readable storage medium. The storage medium mentioned above is a read-only memory, a magnetic disk, a compact disk, or the like.

Described above are merely optional embodiments of the present disclosure and are not intended to limit the present disclosure. Any modifications, equivalents, improvements, and the like, made within the spirit and principle of the present disclosure should fall within the protection scope of the present disclosure.

1. A device access method, wherein the method is applied to a host and comprises:
acquiring a connection request provided by a terminal, wherein the connection request comprises an identifier of the terminal and a password corresponding to the identifier, and the password is generated based on a private key in a key pair and the identifier;
acquiring a verification result of the password, wherein the password is configured to be verified by a public key in the key pair;
establishing a connection with the terminal in response to a successful verification; and
rejecting the connection request of the terminal in response to a failed verification.

2. The method according to claim 1, wherein said acquiring the verification result of the password comprises:
sending the identifier of the terminal and the password corresponding to the identifier to a verifying module, wherein the verifying module is configured to verify the password through the public key in the key pair; and
receiving a verification result fed back by the verifying module.

3. The method according to claim 2, wherein the connection request further comprises a user name corresponding to the identifier, and the password is generated based on the private key in the key pair, the identifier and the user name; and
said sending the identifier of the terminal and the password corresponding to the identifier to the verifying module comprises:
sending the identifier of the terminal, the user name corresponding to the identifier and the password corresponding to the identifier to the verifying module.

4. The method according to claim 1, wherein said acquiring the verification result of the password comprises:
decrypting the password through the public key in the key pair to acquire decrypted data;
generating digest data of the identifier of the terminal;
verifying whether the decrypted data is the same as the digest data;
determining that the verification is successful in response to the decrypted data being the same as the digest data; and
determining that the verification fails in response to the decrypted data differing from the digest data.

5. The method according to claim 1, wherein before the connection request provided by the terminal is acquired, the method further comprises:
acquiring the identifier of the terminal;
generating the password based on the private key in the key pair and the identifier; and
configuring the password into the terminal.

6-7. (canceled)

8. A device access method, wherein the method is applied to a configuration device and comprises:
acquiring a key pair, wherein the key pair comprises a private key and a public key corresponding to the private key;
providing the key pair to a verifying module;
acquiring an identifier of a terminal;
providing the identifier for the verifying module, wherein the verifying module is configured to generate a password based on the private key in the key pair and the identifier;
acquiring a password provided by the verifying module; and
configuring the password into the terminal, wherein the terminal is configured to establish a connection with a host through the password and the identifier.

9. The method according to claim 8, wherein the verifying module is configured to generate a user name of the terminal, and generate the password, based on the private key in the key pair, the user name and the identifier and
said acquiring the password provided by the verifying module comprises:
acquiring the user name and the password which correspond to the identifier provided by the verifying module.

10. A device access system, wherein the system comprises a host and a terminal; wherein
the terminal is configured to send a connection request to the host, wherein the connection request comprises an identifier of the terminal and a password corresponding to the identifier, and the password is generated based on a private key in a key pair and the identifier; and
the host is configured to:
acquire a verification result of the password, wherein the password is configured to be verified by a public key in the key pair;
establish a connection with the terminal in response to a successful verification; and
reject the connection request of the terminal in response to a failed verification.

11. The system according to claim 10, wherein the system further comprises a verifying module,
the host is configured to send the identifier of the terminal and the password corresponding to the identifier to the verifying module;
the verifying module is configured to verify the password through the public key in the key pair; and
the host is configured to receive a verification result fed back by the verifying module.

12. The system according to claim 11, wherein the verifying module is configured to:
decrypt the password through the public key in the key pair to acquire decrypted data;
generate digest data of the identifier of the terminal;
verify whether the decrypted data is the same as the digest data;
determine that the verification is successful in response to the decrypted data being the same as the digest data; and
determine that the verification fails in response to the decrypted data differing from the digest data.

13. A computer storage medium, wherein the computer storage medium stores at least one instruction, at least one program, a code set, or an instruction set therein, and a processor, when loading and executing the at least one instruction, the at least one program, the code set, or the instruction set, is caused to perform the device access method as defined in claim 1.

14. A computer storage medium, wherein the computer storage medium stores at least one instruction, at least one program, a code set, or an instruction set therein, and a processor, when loading and executing the at least one instruction, the at least one program, the code set, or the instruction set, is caused to perform the device access method as defined in 8.
